(19) United States
(12) Patent Application Publication
(10) Pub. No.: US 2025/0112530 A1
(43) Pub. Date: Apr. 3, 2025

(54) ROTATING ELECTRIC MACHINE CORE, ROTATING ELECTRIC MACHINE USING THE SAME, AND METHOD OF MANUFACTURING ROTATING ELECTRIC MACHINE CORE

(71) Applicant: HONDA MOTOR CO., LTD., Tokyo (JP)

(72) Inventors: Hitoshi ITAMI, Saitama (JP); Yoshiyuki NAKAZAWA, Saitama (JP)

(21) Appl. No.: 18/902,953

(22) Filed: Oct. 1, 2024

(30) Foreign Application Priority Data
Oct. 2, 2023 (JP) 2023-171587

(51) Int. Cl. H02K 15/02; H02K 1/02

(52) U.S. Cl. CPC H02K 15/02; H02K 1/02; H02K 2215/00

(57) ABSTRACT

A method of manufacturing a rotating electric machine core, in which the method includes: a localized alloying processing step of forming a localized alloying area by applying localized alloying processing to the leakage magnetic flux reduction area, where an insulating film is applied onto a surface of an individual sheet or a predetermined number of laminated sheets; a pressing and punching step including a pressing step of pressing the localized alloying area so as to be thinner than other portions of the laminating steel sheet, and a punching step of punching the laminating steel sheet into a shape of the rotating electric machine core; and a laminating and forming step of laminating portions that have been thinned, so as to be to aligned to form gaps therebetween, and forming the rotating electric machine core by laminating the other portions in contact with each other through the insulating film.

This application is based on and claims the benefit of priority from Japanese Patent Application No. 2023-171587, filed on 2 Oct. 2023, the content of which is incorporated herein by reference.

### BACKGROUND OF THE INVENTION

### Field of the Invention

The present invention relates to a rotating electric machine core, a rotating electric machine using the same, and a method of manufacturing a rotating electric machine core.

### Related Art

In the case of rotating electric machines using an embedded magnet rotor, there is a demand for higher efficiency by minimizing leakage magnetic flux around the permanent magnet in the rotor yoke. In response to this demand, technologies have been proposed to apply non-magnetic materials to portions corresponding to the leakage magnetic flux path (see, for example, Patent Document 1). Additionally, technologies have been proposed to render the portion corresponding to the eddy current path into a concave shape in the thickness direction to reduce iron loss due to eddy currents around the permanent magnet in the rotor yoke (see, for example, Patent Document 2).
Patent Document 1: Japanese Unexamined Patent Application, Publication No. H8-331784
Patent Document 2: Japanese Patent No. 4631361

### SUMMARY OF THE INVENTION

However, there is still a demand for a technology that is easier to manufacture and is more effective in reducing leakage magnetic flux than the technologies disclosed in Patent Documents 1 and 2 do.

The present invention has been made in view of the such circumstances, and an object of the present invention is to provide a rotating electric machine core, a rotating electric machine using the same, and a method of manufacturing a rotating electric machine core, which apply a localized alloying technique such as laser-cladding for the purpose of non-magnetization of materials, while allowing for overcoming the problem of localized thermal deformation that occurs when applying such a technique.
(1) A rotating electric machine core (for example, a rotor core 2 described later) formed by laminating a laminating steel sheet (for example, a laminating steel sheet 3 described later) that includes a leakage magnetic flux reduction area (for example, a localized alloying area 33 described later), in which the laminating steel sheet includes an insulating film (for example, an insulating film 32 described later) applied to a surface of an individual sheet or a predetermined number of laminated sheets, and the leakage magnetic flux reduction area is formed as a localized alloying portion (for example, a localized alloying area 33 described later) that has undergone the localized alloying processing, and the localized alloying portion is pressed into a shape that creates a gap between laminated surfaces of the laminating steel sheet.
(2) A rotating electric machine (for example, a rotating electric machine 1 described later), including a stator or a rotor that is constructed using the rotating electric machine core as described in (1).
(3) A method of manufacturing a rotating electric machine core (for example, a rotor core 2 described later) formed by laminating a laminating steel sheet (for example, a laminating steel sheet 3 described later) that includes a leakage magnetic flux reduction area (for example, a localized alloying area 33 described later), in which the method includes: a localized alloying processing step (for example, a localized alloying processing step S1 described later) of forming a localized alloying portion (for example, a localized alloying area 33 described later) by applying localized alloying processing to the leakage magnetic flux reduction area, where an insulating film (for example, an insulating film 32 described later) is applied on a surface of an individual sheet or a predetermined number of laminated sheets; a pressing and punching step (for example, a pressing and punching step S2 described later) including a pressing step of pressing the localized alloying portion to be thinner than other portions of the laminating steel sheet, and a punching step of punching the laminating steel sheet into a shape of the rotating electric machine core; and a laminating and forming step (for example, a laminating and forming step S3 described later) of laminating portions that have been thinned in the pressing step in the laminating steel sheet, so as to be to aligned to form gaps therebetween, and forming the rotating electric machine core by laminating other portions of the laminating steel sheet in contact with each other through the insulating film.
(1) According to the rotating electric machine core of the present disclosure, the laminating steel sheet includes an insulating film applied to the surface of the individual sheets or a predetermined number of laminated sheets, and the localized alloying portion that has undergone localized alloying processing at the leakage magnetic flux reduction area is press-formed to create a gap between the localized alloying portions on the laminated surfaces of the laminating steel sheets. The large insulating resistance due to the air in this gap ensures electrical insulation, thereby allowing for suppression of the reduction in machine efficiency caused by eddy currents. In other words, although the localized alloying processing for reducing the leakage magnetic flux has been applied, the electrical insulation in the leakage magnetic flux reduction area with the insulating film being destroyed can be maintained at a high level. Therefore, it is possible to provide a rotating electric machine core that is thinned to address the localized thermal deformation of the laminating steel sheet caused by the localized alloying processing, ensuring high dimensional accuracy and centrifugal strength, and further allowing for a reduction in leakage magnetic flux and suppression of eddy currents.

With the rotating electric machine of the aspect (2), a small and energy-efficient rotating electric machine can be realized by applying a rotating electric machine core composed of the laminating steel sheets that are thinned to address the localized thermal deformation, in which the leakage magnetic flux and eddy currents are effectively reduced.

With the method of manufacturing a rotating electric machine core of the aspect (3), the localized alloying processing step promotes non-magnetization at the leakage magnetic flux reduction area, while the portions that have been thinned and punched into the predetermined shape in the pressing and punching step in the laminating steel sheets are aligned and laminated to form a gap therebetween in the laminating and forming step. As a result, the large insulating resistance of the air in the gap ensures electrical insulation, thereby allowing for suppression of the reduction in machine efficiency caused by eddy currents. The leakage magnetic flux can be reduced by maintaining the high magnetic resistance in the magnetic flux reduction area that has undergone the localized alloying processing, and a small and energy-efficient rotating electric machine can be manufactured through the pressing step to thin the areas thermally deformed due to the localized alloying processing.

### BRIEF DESCRIPTION OF THE DRAWINGS

FIG. 1 is a diagram illustrating a portion of a laminating steel sheet used in a rotor core as a rotating electric machine core that constitutes the rotating electric machine of the present disclosure;

FIG. 2 is a diagram illustrating the magnetic path of a leakage magnetic flux generated near the portion where the rotor core illustrated in FIG. 1 faces the stator;

FIG. 3 is a diagram illustrating the aspect of pressing a portion that has undergone localized alloying processing, in the laminating steel sheet illustrated in FIG. 1;

FIG. 4A is a diagram illustrating the portion that has undergone the localized alloying processing, in the laminating steel sheet;

FIG. 4B is a diagram illustrating the aspect of pressing the portion that has undergone the localized alloying processing as illustrated in FIG. 4A;

FIG. 4C is a diagram illustrating the aspect of forming a slot by punching portions including an escape portion expanded during the pressing illustrated in FIG. 4B;

FIG. 5A is a diagram illustrating the portion that has undergone the localized alloying processing, in the laminating steel sheet;

FIG. 5B is a diagram illustrating the aspect of forming a slot by punching after the localized alloying processing illustrated in FIG. 5A;

FIG. 5C is a diagram illustrating the aspect of pressing the portion that has undergone the localized alloying processing illustrated in FIG. 5A;

FIG. 5D is a diagram illustrating the aspect of forming by punching the escape portion expanded during the pressing illustrated in FIG. 5C;

FIG. 6A is a diagram illustrating the portion that has undergone the localized alloying processing, in the laminating steel sheet;

FIG. 6B is a diagram illustrating the aspect of forming a slot by punching portions including the portion expanded during the localized alloying processing illustrated in FIG. 6A;

FIG. 6C is a diagram illustrating the aspect of pressing the yoke portion that has become narrower than specified by the punching illustrated in FIG. 6B;

FIG. 7 is a schematic diagram illustrating the aspect of laminating and forming the laminating steel sheets to constitute the rotating electric machine core of the present disclosure; and

FIG. 8 is a step diagram illustrating the steps involved in the method of manufacturing the rotating electric machine core of the present disclosure.

### DETAILED DESCRIPTION OF THE INVENTION

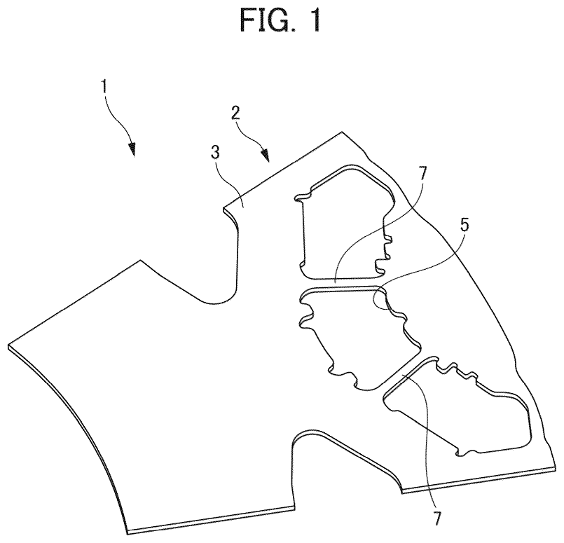

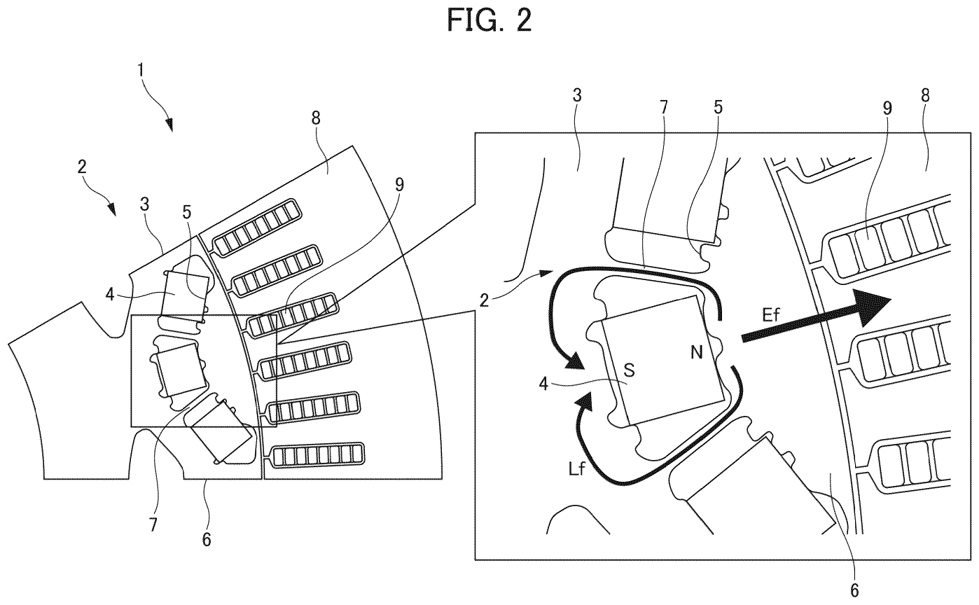

Next, embodiments of the present invention will be described with reference to the drawings. In each of the drawings described below, the same reference numerals are used to designate identical or corresponding parts. FIG. 1 is a diagram illustrating a portion of the laminating steel sheet 3 used for the rotor core 2 serving as a rotating electric machine core that constitutes the rotating electric machine 1 of the present disclosure; and FIG. 2 is a diagram illustrating the magnetic path of the leakage magnetic flux generated near a portion of the rotor core 2 (illustrated in FIG. 1) facing the stator core 8. The rotating electric machine 1 of the present disclosure is an Interior Permanent Magnet (IPM) motor, which is used in electric vehicles and other applications. A plurality of magnets 4 are accommodated in a circumferential arrangement near the outer periphery of the rotor core 2.

The rotor core 2 is formed by laminating a plurality of laminating steel sheets 3 with the main surfaces aligned with each other. Slots 5 accommodating and holding the magnets 4 are formed in the outer peripheral surface of the rotor core 2. In the following description, the portions of the laminating steel sheets 3 constituting the shape of the slots 5 will also be referred to as slots 5 as appropriate. The magnets 4 are held within the rotor core 2, thereby forming the rotor 6 of the rotating electric machine 1.

In the rotating electric machine 1 that is the IPM motor, reinforcement ribs 7 for ensuring the centrifugal strength of the rotor 6 are provided near the magnets 4 in the laminating steel sheet 3 so as to span radially across the outer and inner peripheral sides of the slots 5. During the operation of the rotating electric machine 1, a return flux, which is a leakage magnetic flux Lf, occurs in the reinforcement ribs 7, interacting with the magnetic flux from the coil 9 on the stator core 8 side, thereby reducing the effective magnetic flux Ef that generates torque, and degrading the performance of the rotating electric machine 1.

In order to suppress the leakage magnetic flux Lf in the reinforcement ribs 7, one option is to make the reinforcement ribs 7 as thin as possible. However, this approach reduces the mechanical strength of the reinforcement ribs 7, causing issues with maintaining centrifugal strength. Therefore, non-magnetization of the reinforcement ribs 7 will be effective. In this case, complete non-magnetization may not be necessary, and a reasonable effect can be achieved by significantly reducing the magnetic permeability to the extent that the leakage magnetic flux Lf decreases.

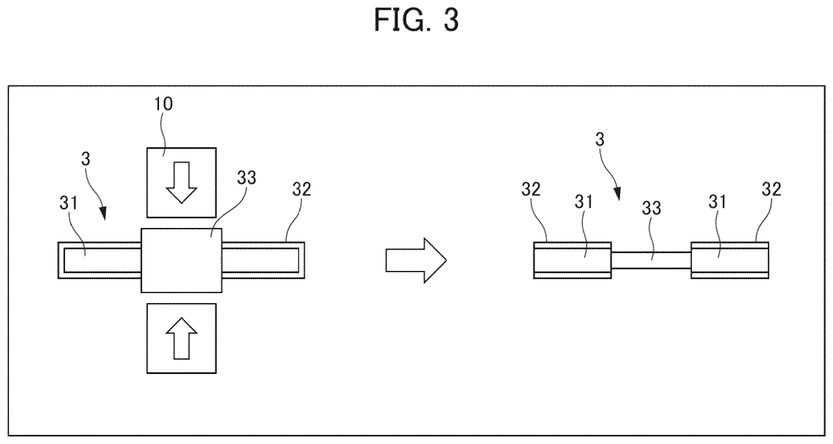

The non-magnetization processing is applied to the reinforcement ribs 7, for example, by laser-cladding a non-magnetic forming element onto the laminating steel sheet 3 that is an electromagnetic steel sheet. However, adding materials other than the electromagnetic steel sheet causes deformation (i.e., localized thermal deformation). The heat generated during the laser-cladding process destroys the insulating film 32 on the surface of the laminating steel sheet 3 (see FIG. 3).

When the insulating film 32 on the surface of the laminating steel sheet 3 is destroyed, the electrical insulation in the thickness direction is lost during the laminating and forming of the laminating steel sheets 3 when forming the rotor 6, leading to motor loss (iron loss) due to eddy currents, thereby degrading the efficiency of the motor. The deformation caused by laser-cladding primarily increases the thickness of the sheet, such that the required dimensions during the laminating and forming of the laminating steel sheet 3 when forming the rotor 6 cannot be satisfied.

Therefore, with the rotor core 2 that is the rotating electric machine core of the present disclosure, the thickness of the laser-clad portion is reduced by pressing after laser-cladding. By pressing the laser-clad portion to reduce the thickness so as to be thinner than the non-laser-clad portion, it is possible to satisfy the dimensional requirements for the laminating and forming process when forming the rotor core 2. Simultaneously, the gap formed between the sheets during the laminating and forming of the laminating steel sheets 3 can ensure electrical insulation due to the large insulating resistance of the air, thereby suppressing the reduction in electric machine efficiency caused by eddy currents.

FIG. 3 is a diagram illustrating the aspect of pressing the portion that has undergone the localized alloying processing, in the laminating steel sheet 3 illustrated in FIG. 1. An insulating film 32 is applied onto an electromagnetic steel sheet 31 that is the material of the laminating steel sheet 3. The localized alloying area 33, which has undergone the localized alloying processing, is thermally deformed and bulged in the thickness direction, with the insulating film 32 destroyed. The deformed localized alloying area 33 of the laminating steel sheet 3 is press-formed into the shape of the rotor core 2, and simultaneously pressed from both sides in the thickness direction using the same press machine 10.

The localized alloying area 33 is pressed in this manner so as to be thinner than the original thickness of the electromagnetic steel sheet 31 that is the material of the laminating steel sheet 3. The thinned portions of the laminating steel sheet 3 are aligned and laminated to form a gap therebetween. Even in the portions where the insulating film 32 has been destroyed, high insulation is achieved through the large insulating resistance of the air in the gaps formed in this manner.

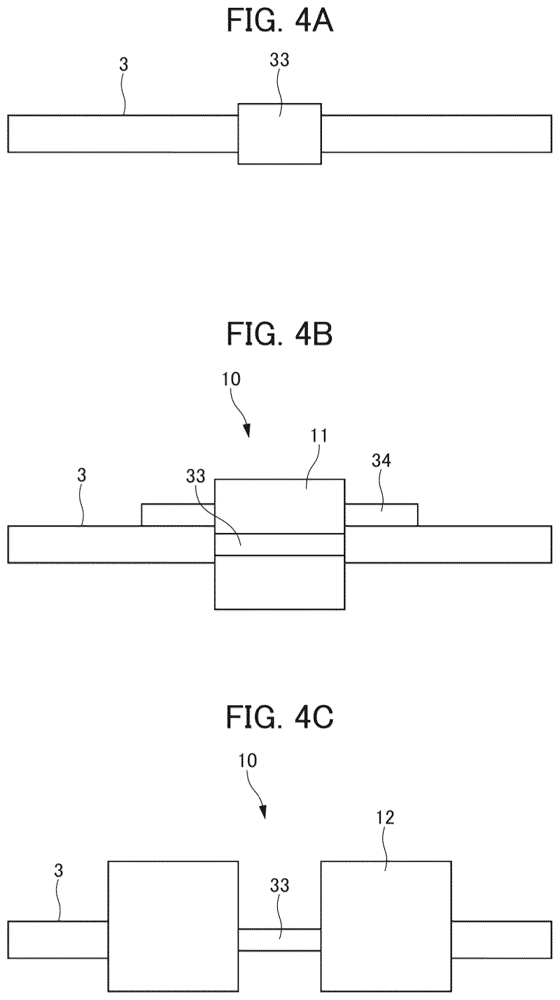

Next, with reference to FIGS. 4A, 4B, and 4C, the following describes an example of the step of pressing the portion that has undergone the localized alloying processing in the laminating steel sheet 3, and the step of forming a slot (the slot 5 for holding the magnet 4) by punching. FIG. 4A is a diagram illustrating the localized alloying area 33 formed by applying the localized alloying processing to the laminating steel sheet 3. As described with reference to FIG. 3, the localized alloying area 33 is thermally deformed and bulged in the thickness direction, increasing the thickness dimension at that area when laminating and forming the laminating steel sheet 3 to form the rotor core 2, thus hindering normal formation and lamination in which the surfaces are in close contact with each other. Specifically, the specified dimensions for laminating and forming the laminating steel sheets 3 cannot be satisfied when forming the rotor core 2.

Therefore, as illustrated in FIG. 4B, the localized alloying area 33 is compressed by the press die for pressing 11 (punch) of the press machine 10 to a thickness dimension smaller than the surrounding portions that have not undergone the localized alloying processing in the laminating steel sheet 3. When the thermally deformed localized alloying area 33 is compressed in the thickness direction in the processing illustrated in FIG. 4B, the material may escape around the localized alloying area 33 and create a bulged area 34 that is bulged in the thickness direction. The bulged area 34 is also created to expand both toward the front and rear sides of the paper plane in FIG. 4B.

In the processing illustrated in FIG. 4C, the portions including the bulged area 34, which expanded during the pressing process illustrated in FIG. 4B, are punched out using the press die for punching 12 of the press machine 10, forming the shape of the slot 5 of the rotor core 2. This removes the unnecessary protruding portions in the thickness direction from the main surface of the laminating steel sheet 3, allowing the laminating steel sheets 3 to be formed and laminated in tight contact and the rotor core 2 to be formed with the normal dimensions.

Since the press die for pressing 11 (punch) and the press die for punching 12 of the same press machine 10 compress the bulged area 34 in the thickness direction and punch the bulged area 34 into the shape of the slot 5, respectively, the processing illustrated in FIG. 4B and FIG. 4C can be carried out as a single process, enabling efficient and low-cost manufacturing of the rotating electric machine 1.

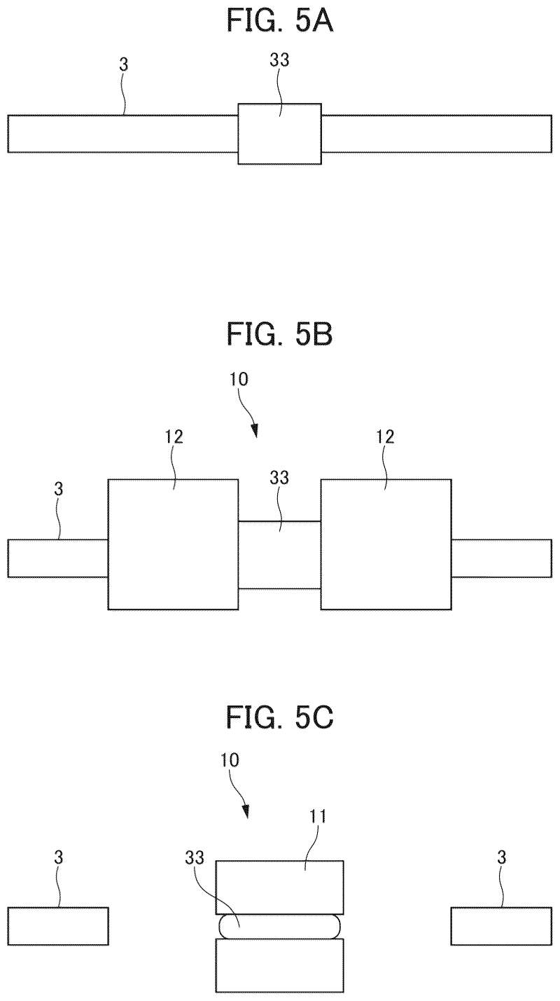

Next, with reference to FIGS. 5A, 5B, 5C, and 5D, the following describes another example of the step of pressing the portion that has undergone the localized alloying processing in the laminating steel sheet 3, and the step of forming the slot 5 of the rotor core 2 by punching. FIG. 5A is a diagram illustrating the localized alloying area 33 formed by applying the localized alloying processing to the laminating steel sheet 3. As described with reference to FIG. 3, the localized alloying area 33 is thermally deformed and bulged in the thickness direction, increasing the thickness dimension at that location when laminating and forming the laminating steel sheet 3 to form the rotor core 2, thus hindering normal formation and lamination in which the surfaces are in close contact with each other.

Next, in this processing step, as illustrated in FIG. 5B, the area around the localized alloying area 33 is punched out using the press die for punching 12 of the press machine 10 to form the shape of the slot 5.

Further, in the processing illustrated in FIG. 5C, the localized alloying area 33, which retains the state of being thermally deformed and bulged in the thickness direction in the previous step as illustrated in FIG. 5B, is compressed by the press die for pressing 11 (punch) of the press machine 10 to a thickness dimension smaller than the surrounding portions that have not undergone the localized alloying processing. When the thermally deformed localized alloying area 33 is compressed in the thickness direction by the processing as illustrated in FIG. 5C, the material may escape around the localized alloying area 33 and expand in the plane direction. The portion expanding in the plane direction may also be created both toward the front and rear sides of the paper plane in FIG. 5C.

In the processing illustrated in FIG. 5D, the portions that have expanded in the plane direction during the pressing process as illustrated in FIG. 5C are punched out using the press die for punching 12a of the press machine 10 to trim the planar shape. This removes the unnecessary protruding portions in the thickness direction from the main surface of the laminating steel sheet 3, allowing the laminating steel sheets 3 to be formed and laminated in tight contact and the rotor core 2 to be formed with the normal dimensions. In some cases, the portions that have expanded in the plane direction during the pressing process as illustrated in FIG. 5C may not need to be removed. In such cases, the processing step illustrated in FIG. 5D need not be executed.

Since the press die for pressing 11 (punch) and the press die for punching 12 of the same press machine 10 compress the bulged area 34 in the thickness direction and punch the bulged area 34 into the shape of the slot 5, respectively, the processing steps from FIG. 5B to FIG. 5D can be carried out as a single process, enabling efficient and low-cost manufacturing of the rotating electric machine 1.

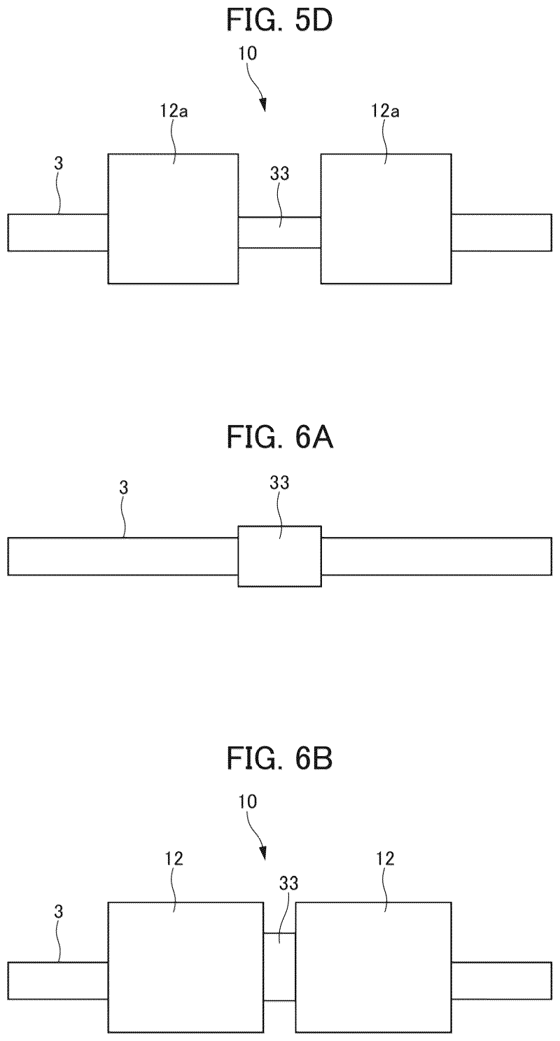

Next, with reference to FIGS. 6A, 6B, and 6C, the following describes yet another example of the step of pressing the portion that has undergone the localized alloying processing in the laminating steel sheet 3, and the step of forming the slot 5 of the rotor core 2 by punching. FIG. 6A is a diagram illustrating the localized alloying area 33 formed by applying the localized alloying processing to the laminating steel sheet 3. As described with reference to FIG. 3, the localized alloying area 33 is thermally deformed and bulged in the thickness direction, increasing the thickness dimension at that area when laminating and forming the laminating steel sheet 3 to form the rotor core 2, thus hindering normal formation and lamination in which the surfaces are in close contact with each other.

Next, as illustrated in FIG. 6B, the portion partly including the outer edge portion of the localized alloying area 33 itself is punched out using the press die for punching 12 of the press machine 10, forming the shape of the slot 5. Immediately after executing the processing step illustrated in FIG. 6B, the localized alloying area 33 becomes slightly smaller than the specified planar projection shape dimension.

Further, in the processing step illustrated in FIG. 6C, the localized alloying area 33, which retains the state of being thermally deformed and bulged in the thickness direction in the previous step as illustrated in FIG. 6B, is compressed by the press die for pressing 11 (punch) of the press machine 10 to a thickness dimension smaller than the surrounding portions that have not undergone the localized alloying processing. When the thermally deformed localized alloying area 33 is compressed in the thickness direction by the processing illustrated in FIG. 6C, the material escapes around the localized alloying area 33 and expands in the plane direction. However, the localized alloying area 33 has become slightly smaller than the specified planar projection shape dimension after executing the processing step illustrated in FIG. 6B. Therefore, the expansion in the plane direction during the processing in FIG. 6C will result in precisely the specified planar projection shape dimension.

Since the press die for pressing 11 (punch) and the press die for punching 12 of the same press machine 10 compress the bulged area 34 in the thickness direction and punch the bulged area 34 into the shape of the slot 5, respectively, the processing steps from FIG. 6B to FIG. 6C can be carried out as a single process, enabling efficient and low-cost manufacturing of the rotating electric machine 1.

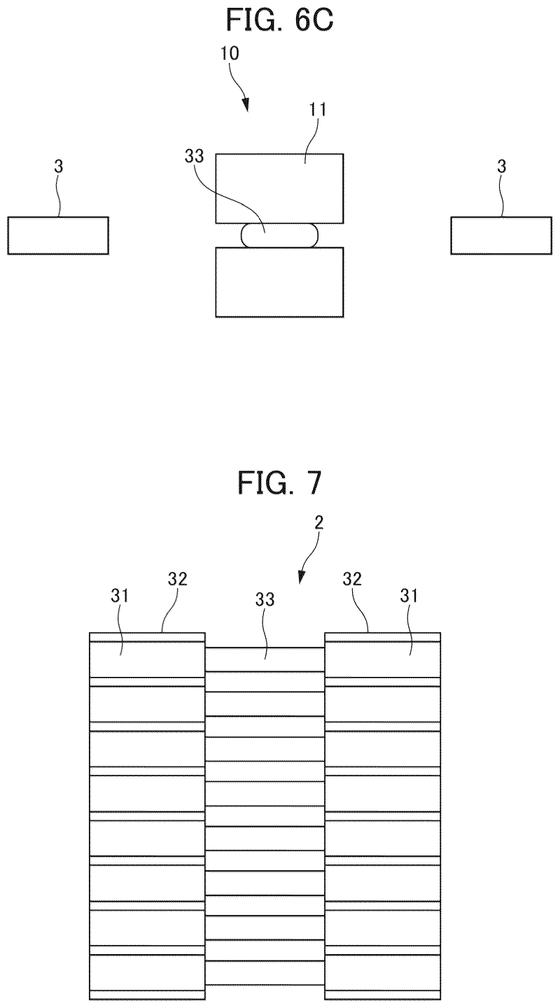

FIG. 7 is a schematic diagram illustrating the aspect of laminating and forming the laminating steel sheets 3 to constitute the rotating electric machine core (one example being the rotor core 2) of the present disclosure. As described with reference to FIG. 3, the insulating film 32 is applied to the electromagnetic steel sheet 31 that is the laminating steel sheet 3, partly constituting the localized alloying area 33. Although the insulating film 32 on the localized alloying area 33 is destroyed, the localized alloying area 33 is pressed so as to be thinner than the original thickness of the electromagnetic steel sheet 31 that is the material of the laminating steel sheet 3. The thinned portions of the laminating steel sheet 3 are aligned and laminated to form gaps therebetween. The other portions of the laminating steel sheet 3 are laminated in contact with each other through the insulating film 32. Even in the portions where the insulating film 32 is partly destroyed, a high insulation effect is achieved through the large insulating resistance of the air in the gaps formed as described above.

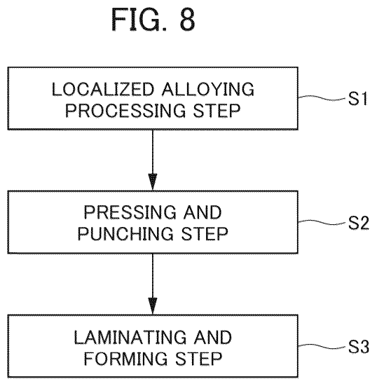

Next, the steps included in the method of manufacturing the rotating electric machine core of the present disclosure will be described with reference to FIG. 8 that is a step diagram together with the drawings previously described as appropriate. The method of manufacturing the rotating electric machine core of the present disclosure is a method of manufacturing a rotating electric machine core (one example being the rotor core 2) formed by laminating steel sheets that include a leakage magnetic flux reduction area.

First, in the localized alloying processing step S1, a localized alloying area is formed by applying the localized alloying processing to the leakage magnetic flux reduction portion, where an insulating film 32 has been applied onto the surfaces of individual sheets and/or a group of predetermined number of laminating steel sheet 3.

Next, in the pressing and punching step S2, the localized alloying area 33 is pressed so as to be thinner than other portions of the laminating steel sheet 3, and the laminating steel sheet 3 is punched into a predetermined shape. As described above with reference to FIGS. 4B and 4C, punching may be executed after pressing, or as described above with reference to FIGS. 5B and 5C, and FIGS. 6B and 6C, punching may be executed first, followed by pressing.

In the laminating and forming step S3, as described with reference to FIG. 7, the localized alloying area 33, which have been thinned by pressing in the pressing and punching step S2, are aligned and laminated so as to form gaps therebetween, while other portions of the laminating steel sheet 3 are formed and laminated in contact with each other through the insulating film 32, thereby forming the rotating electric machine core (rotor core 2).

According to the rotating electric machine 1 of the present disclosure, the following effects can be achieved:
With the rotating electric machine core (rotor core 2) according to the aspect (1) of the present disclosure, the laminating steel sheets 3 include an insulating film 32 applied to the surface of the individual sheets or a group of predetermined number of laminated sheets, and the localized alloying portions (localized alloying areas 33,) where the localized alloying processing has been applied to the leakage magnetic flux reduction area, is press-formed to create gaps between the localized alloying portions on the laminated surfaces of the laminating steel sheets 3. These gaps, with the large insulating resistance of the air, can ensure electrical insulation, thereby suppressing the reduction in electric machine efficiency caused by eddy currents. In other words, although the localized alloying processing for reducing the leakage magnetic flux has been applied, the electrical insulation in the leakage magnetic flux reduction area with the insulating film 32 being destroyed can be maintained at a high level. Therefore, it is possible to provide a rotating electric machine core (rotor core 2) that is thinned to address the localized thermal deformation of the laminating steel sheets 3 caused by the localized alloying processing, ensuring high dimensional accuracy, maintaining centrifugal strength, and allowing for a further reduction in leakage magnetic flux and suppression of eddy currents.
With the rotating electric machine 1 according to the aspect (2) of the present disclosure, a small and energy-efficient rotating electric machine 1 can be achieved by using a rotating electric machine core (rotor core 2) composed of laminating steel sheets that effectively reduce a leakage magnetic flux and eddy currents and are thinned to address localized thermal deformation.
With the method of manufacturing the rotating electric machine core according to the aspect (3) of the present disclosure, the localized alloying processing step S1 promotes non-magnetization at the leakage magnetic flux reduction area; and the laminating steel sheets that are thinned and punched into a predetermined shape in the pressing and punching step S2 are aligned and laminated to form gaps therebetween in the laminating and forming step S3. This ensures electrical insulation through the large insulating resistance of the air in the gaps, thereby allowing for suppression of the reduction in electric machine efficiency caused by eddy currents. The leakage magnetic flux can be reduced by maintaining the high magnetic resistance in the magnetic flux reduction area that has undergone the localized alloying processing, and a small and energy-efficient rotating electric machine can be manufactured by thinning and pressing the areas thermally deformed by the localized alloying processing.

The rotating electric machine core, the rotating electric machine using the same, and the method of manufacturing the rotating electric machine core of the present disclosure have been described above; however, the present invention is not limited thereto. The detailed configuration may be appropriately modified within the scope and spirit of the present invention. For example, while the rotating electric machine described above is an IPM (Interior Permanent Magnet) motor, the same configuration and similar effects can be achieved in cases where the rotating electric machine is an IPM power generator.

### EXPLANATION OF REFERENCE NUMERALS

1: rotating electric machine
2: rotor core
3: laminating steel sheet
4: magnet
5: slot
6: rotor
7: reinforcement rib
8: stator core
9: coil
10: press machine
11: press die for pressing
12, 12a: press die for punching
31: electromagnetic steel sheet
32: insulating film
33: localized alloying area
34: bulged area

What is claimed is:

1. A rotating electric machine core formed by laminating a laminating steel sheet that includes a leakage magnetic flux reduction area,
the laminating steel sheet comprising an insulating film applied to a surface of an individual sheet or a predetermined number of laminated sheets,
wherein the leakage magnetic flux reduction area is formed as a localized alloying portion that has undergone localized alloying processing, and
the localized alloying portion is pressed into a shape that creates a gap between laminated surfaces of the laminating steel sheet.

2. A rotating electric machine, comprising a stator or rotor that is constructed using the rotating electric machine core according to claim 1.

3. A method of manufacturing a rotating electric machine core formed by laminating a laminating steel sheet that includes a leakage magnetic flux reduction area, the method comprising:
a localized alloying processing step of forming a localized alloying area by applying localized alloying processing to the leakage magnetic flux reduction area, where an insulating film is applied onto a surface of an individual sheet or a predetermined number of laminated sheets of the laminating steel sheets;
a pressing and punching step including a pressing step of pressing the localized alloying area so as to be thinner than other portions of the laminating steel sheet, and a punching step of punching the laminating steel sheet into a shape of the rotating electric machine core; and
a laminating and forming step of laminating portions that have been thinned in the pressing step in the laminating steel sheet, so as to be to aligned to form gaps therebetween, and forming the rotating electric machine core by laminating other portions of the laminating steel sheet in contact with each other through the insulating film.
